(19) United States
(12) Patent Application Publication
(10) Pub. No.: US 2015/0216196 A1
(43) Pub. Date: Aug. 6, 2015

(54) Perforated Grilling Foil

(71) Applicant: Marshall Grier, Las Vegas, NV (US)

(72) Inventor: Marshall Grier, Las Vegas, NV (US)

(21) Appl. No.: 14/610,729

(22) Filed: Jan. 30, 2015

Related U.S. Application Data
(60) Provisional application No. 61/933,980, filed on Jan. 31, 2014.

(51) Int. Cl. A23B 4/052

(52) U.S. Cl. CPC A23B 4/0523

(57) ABSTRACT

A perforated grilling foil is an apparatus for use when grilling various foods such as meats, fishes, and vegetables on a charcoal or wood grill. The apparatus includes a malleable metallic sheet and a non-stick grip coating that prevents food from becoming stuck to the malleable metallic sheet. The user is able to form a pouch to contain food during the grilling process by crimping the margin portion of the malleable metallic sheet in order to perimetrically seal the food within the pouch. The apparatus additionally includes a plurality of ventilation holes that allow flavored smoke to enter the pouch and come into contact with the food during the grilling process. The apparatus is available in two configurations in which the plurality of ventilation holes are arranged into offset ventilation hole sets and a configuration in which the plurality of ventilation holes is arranged into a uniformly-spaced set of holes.

The current application claims a priority to the U.S. Provisional Patent application Ser. No. 61/933,980 filed on Jan. 31, 2014.

### FIELD OF THE INVENTION

The present invention relates generally to an apparatus for use in grilling foods.

More specifically, the present invention is a perforated grilling foil that is utilized to separate food from a grilling surface while allowing charcoal and wood flavored smoke to enhance the flavor of the food.

### BACKGROUND OF THE INVENTION

Grilling is a very common method of cooking foods such as meats, fish, and vegetables. Grilling foods on a conventional grilling base is a popular activity, particularly in warm weather. When cooking food on a grill, the food is typically placed onto a grate and exposed to heat that is directed onto the food from directly below the grate. Grilling is popular due to this exposure of food items to flavor-enhancing smoke that is able to come into contact with the food items. A common issue with grilling thin-depth food items or placing food items on various locations on the grate is the tendency for the food items to fall into the heat source and become ruined and wasted.

The present invention is a perforated grilling foil that separates food items from a grilling surface while allowing charcoal and wood flavored smoke to come into contact with the food items. The present invention may be placed directly onto a grate in order to prevent the food items from falling through the gaps in the grate. In addition to serving as a supporting surface for food items when grilling, the present invention may additionally be folded into a pouch to enclose food items within the pouch. When the food items are enclosed within the pouch, the perforations of the present invention allow the smoke to enter the interior of the pouch and come into contact with the food items.

### BRIEF DESCRIPTION OF THE DRAWINGS

FIG. 1 is a perspective view of a first embodiment of the present invention, wherein the first embodiment has offset ventilation hole sets.

FIG. 2 is a top exploded perspective view of the malleable metallic sheet and the non-stick grip coating in the first embodiment.

FIG. 3 is a bottom exploded perspective view of the malleable metallic sheet and the non-stick grip coating in the first embodiment.

FIG. 4 is a perspective view of a second embodiment of the present invention , wherein the second embodiment has a uniformly-spaced set of holes.

FIG. 5 is a side view of the present invention.

FIG. 6 is a detail view of the present invention taken along circle A from FIG. 5.

FIG. 7 is a top view of the malleable metallic sheet.

FIG. 8 is a detail view of the malleable metallic sheet and the plurality of ventilation holes taken along circle B from FIG. 7.

FIG. 9 is a perspective view of the second embodiment in a folded position.

FIG. 10 is a perspective view of the second embodiment in the folded position with a portion of uncooked food.

FIG. 11 is a perspective view of the first embodiment with a chosen set of hole sets.

FIG. 12 is a perspective view of the first embodiment with a chosen set of hole sets in a folded position and with a portion of uncooked food.

FIG. 13 is a perspective view of either the first embodiment or the second embodiment in a pouch configuration.

FIG. 14 is a perspective view of the present invention in the pouch configuration and placed on top of the grilling surface of a grill.

FIG. 15 is a top view of the present invention in the pouch configuration and placed on top of the grilling surface of a grill.

FIG. 16 is a cross-sectional view of the present invention in a pouch configuration and placed on top of the grilling surface of a grill taken along line C-C of FIG. 15.

### DETAIL DESCRIPTIONS OF THE INVENTION

All illustrations of the drawings are for the purpose of describing selected versions of the present invention and are not intended to limit the scope of the present invention.

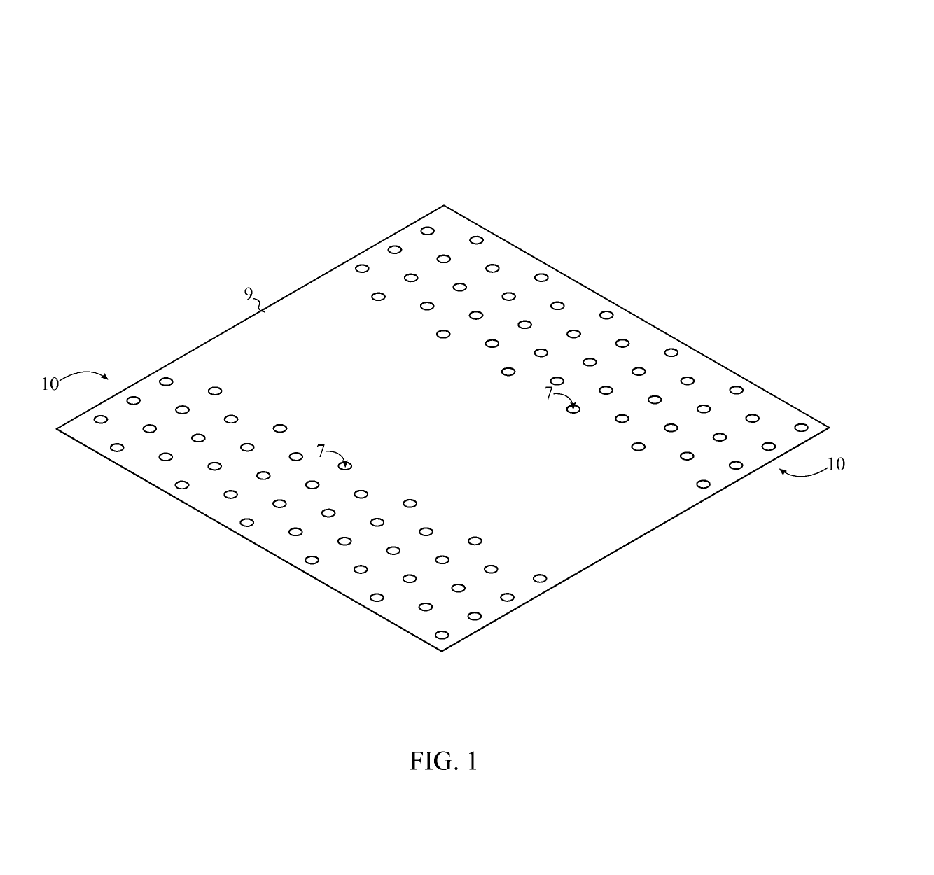

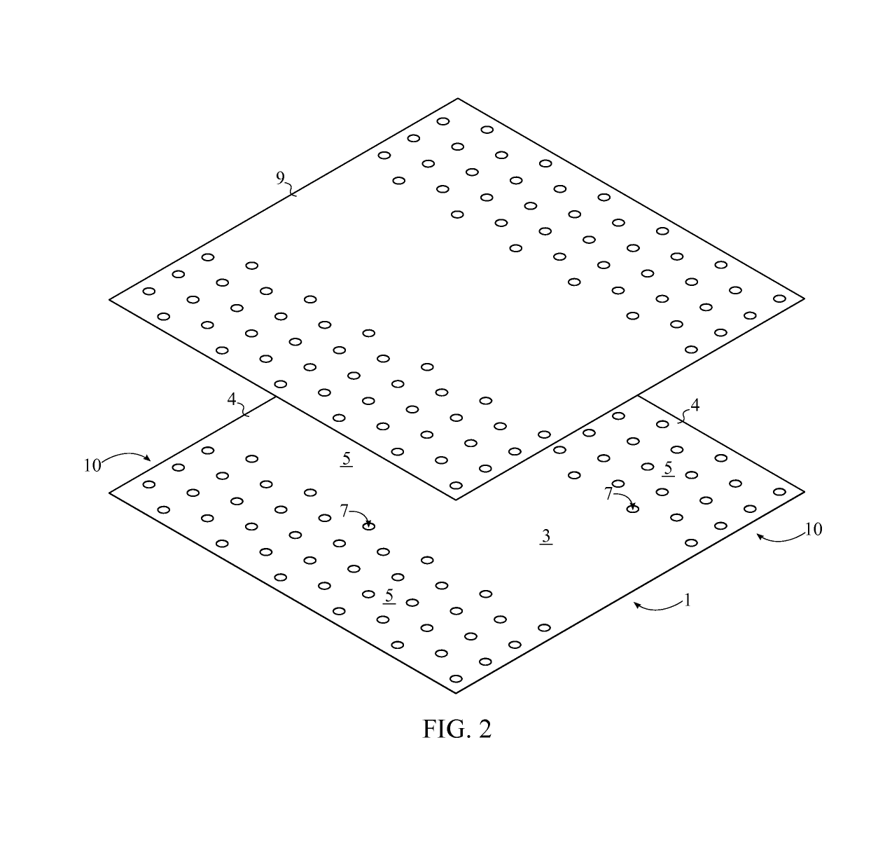

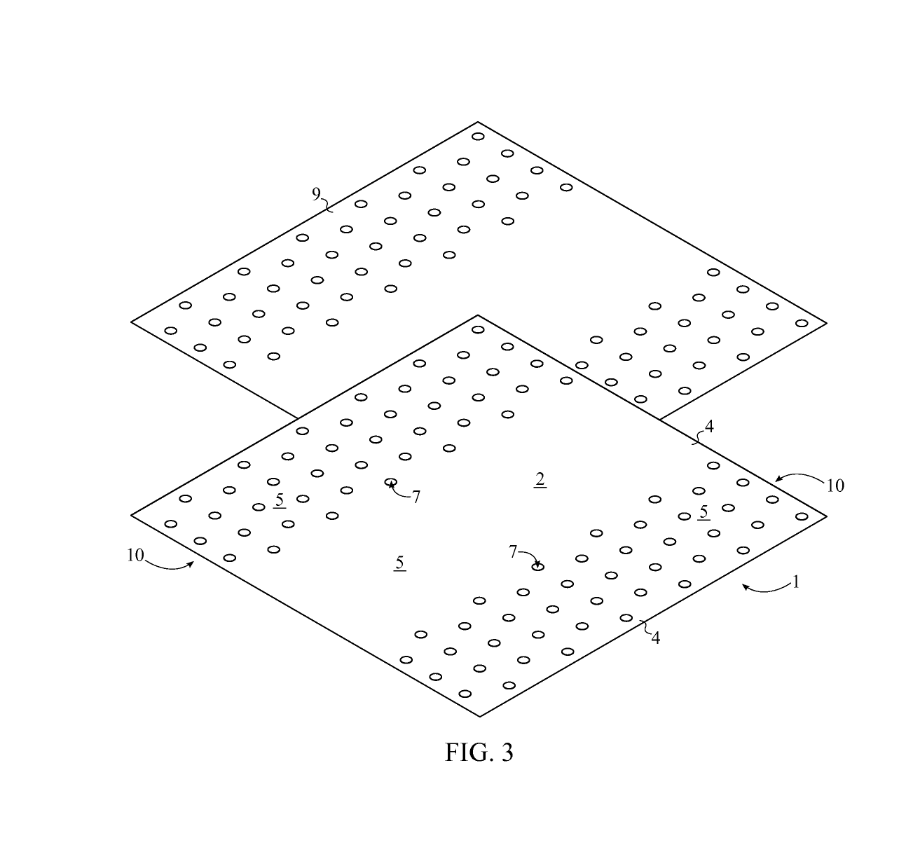

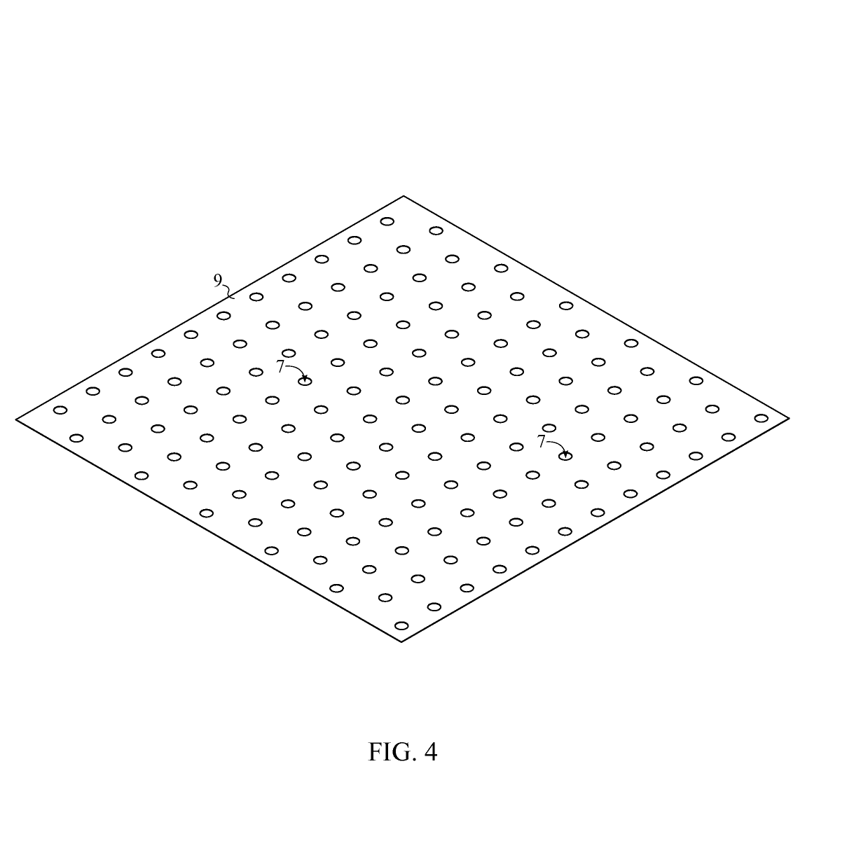

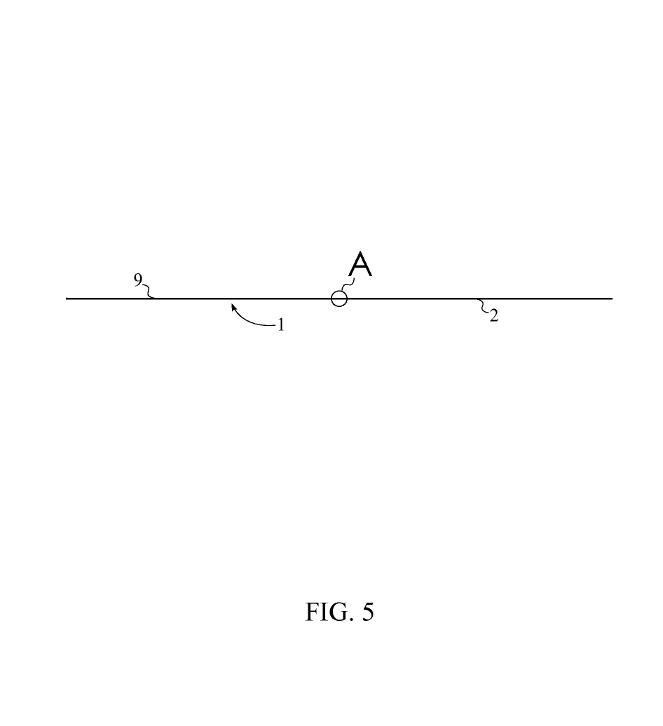

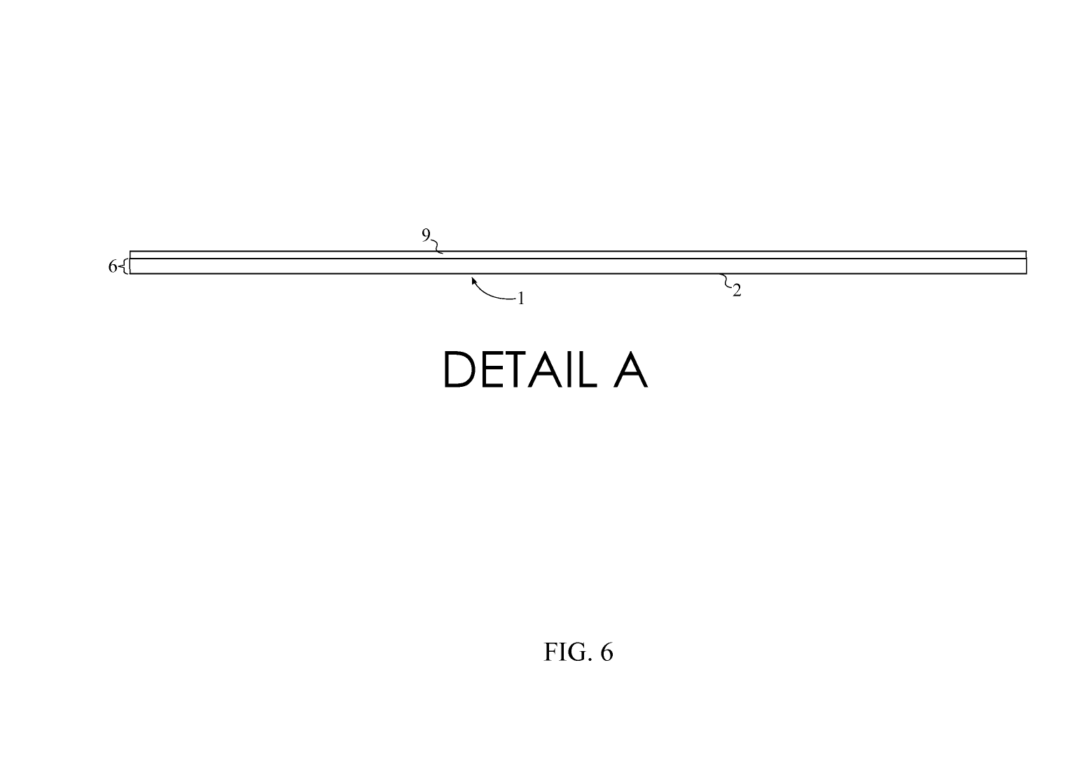

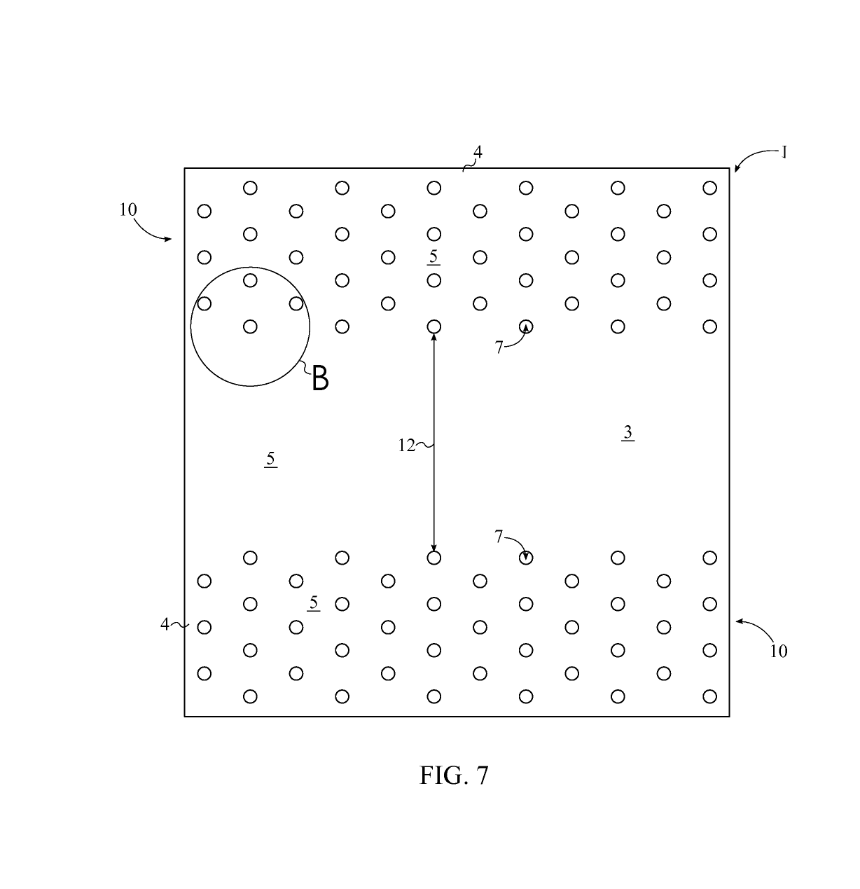

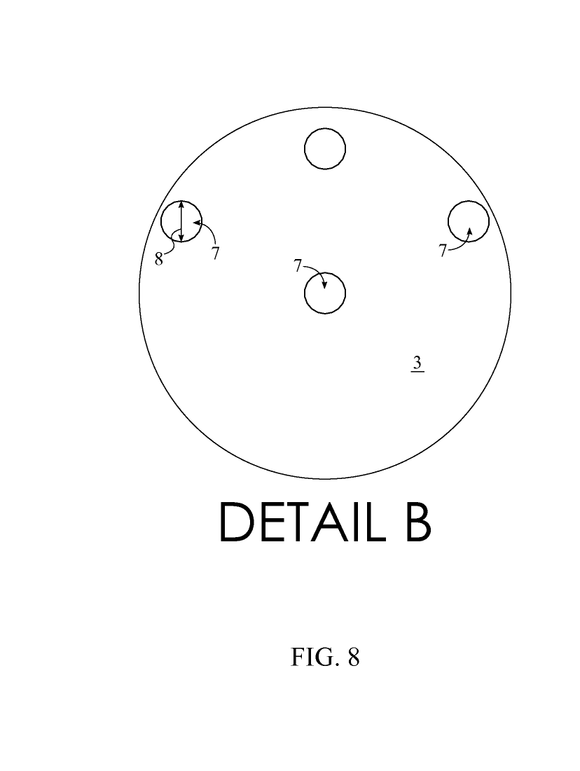

The present invention is a perforated grilling foil that is utilized to separate food items from a grilling surface while allowing charcoal and wood flavored smoke to come into contact with the food items. The present invention is shown in FIGS. 1-8 with a first embodiment of the present invention shown in FIG. 1 and a second embodiment of the present invention shown in FIG. 4. The present invention comprises a malleable metallic sheet 1, a plurality of ventilation holes 7, and a non-stick grip coating 9. The malleable metallic sheet 1 provides a clean surface onto which food may be placed during the grilling process. In the preferred embodiment of the present invention, the malleable metallic sheet 1 is made of aluminum as aluminum is more malleable than tin and does not transmit a metallic taste to food that is placed into contact with the malleable metallic sheet 1. The malleable metallic sheet 1 may be manipulated by the user in order to form pockets and pouches for containing food. The malleable metallic sheet 1 comprises a first surface 2, a second surface 3, a margin portion 4, and a food-contact portion 5. The first surface 2 and the second surface 3 are oppositely facing surfaces of the malleable metallic sheet 1. The margin portion 4 allows the user to crimp and otherwise manipulate the malleable metallic sheet 1 when forming pockets and pouches. Food to be grilled is placed onto the food-contact portion 5 prior the grilling process. As shown in FIG. 2 and FIG. 3, the first surface 2 and the second surface 3 are positioned opposite to each other such that the first surface 2 is oriented toward the grilling surface and the second surface 3 is oriented toward the food. The margin portion 4 is peripherally positioned around the food-contact portion 5. As such, the margin portion 4 may be crimped and otherwise manipulated to form a perimeter around the food-contact portion 5 when creating a pocket or pouch. With reference to FIG. 5 and FIG. 6, in the preferred embodiment of the present invention, the optimal thickness 6 of the malleable metallic sheet 1 is 0.25 microns. This thickness provides a degree of sturdiness and stability to the malleable metallic sheet 1. The plurality of ventilation holes 7 allows charcoal and wood flavored smoke to come into contact with food during the grilling process, enhancing the flavor of the food. The plurality of ventilation holes 7 is distributed across the food-contact portion 5 in order to allow smoke to come into contact with food placed on the food-contact portion 5 during the grilling process in order to enhance the flavor of the food. The plurality of ventilation holes 7 traverses through the food-contact portion 5 from the first surface 2 to the second surface 3. This allows smoke that is produced during grilling to pass from the first surface 2 to the second surface 3 onto which food is placed. With reference to FIG. 7 and FIG. 8, in the preferred embodiment of the present invention, the optimal diameter 8 of each of the plurality of ventilation holes 7 is 7 millimeters. Each of the plurality of ventilation holes 7 is sufficiently sized to allow smoke to pass through while preventing food items from falling through the plurality of ventilation holes 7. The present invention is not limited with respect to the specific number of ventilation holes included in the plurality of ventilation holes 7 nor with respect to any specific pattern or design of the plurality of ventilation holes 7.

The non-stick grip coating 9 prevents food from becoming stuck to the present invention during the grilling process. Again with reference to FIG. 2 and FIG. 3, the non-stick grip coating 9 is superimposed upon the second surface 3 as the second surface 3 is oriented toward food that is grilled utilizing the present invention. The non-stick grip coating 9 additionally aids the user in identifying which side of the present invention upon which food may be placed as the non-stick grip coating 9 may be easily identified by touch. Additionally, the non-stick grip coating 9 is heat-tolerant in order to remain effective during the grilling process.

In the first embodiment of the present invention shown in FIG. 1, the plurality of ventilation holes 7 is arranged into a plurality of ventilation hole sets 10. By organizing the plurality of ventilation holes 7 into a plurality of ventilation hole sets 10, a portion of the malleable metallic sheet 1 remains solid. The plurality of ventilation hole sets 10 is offset from each other across the surface of the malleable metallic sheet 1. As such, the user may place a food item onto a solid portion of the malleable metallic sheet 1. This is particularly useful if the user seeks to retain sauces, seasonings, and juices that may normally fall through the grilling surface when the food is placed over the plurality of ventilation holes 7. In the preferred embodiment of the present invention, the plurality of ventilation hole sets 10 is offset from each other by a specified distance 12 of 152.4 millimeters as shown in FIG. 7.

In the second embodiment of the present invention shown in FIG. 4, the plurality of ventilation holes 7 is arranged into a uniformly-spaced set of holes. In contrast to the first embodiment of the present invention, there is no solid portion of the malleable metallic sheet 1 due to the uniformly-spaced set of holes. The uniformly-spaced set of holes is positioned across the food-contact portion 5. As such, the uniformly-spaced set of holes is distributed along the entire surface of the malleable metallic sheet 1.

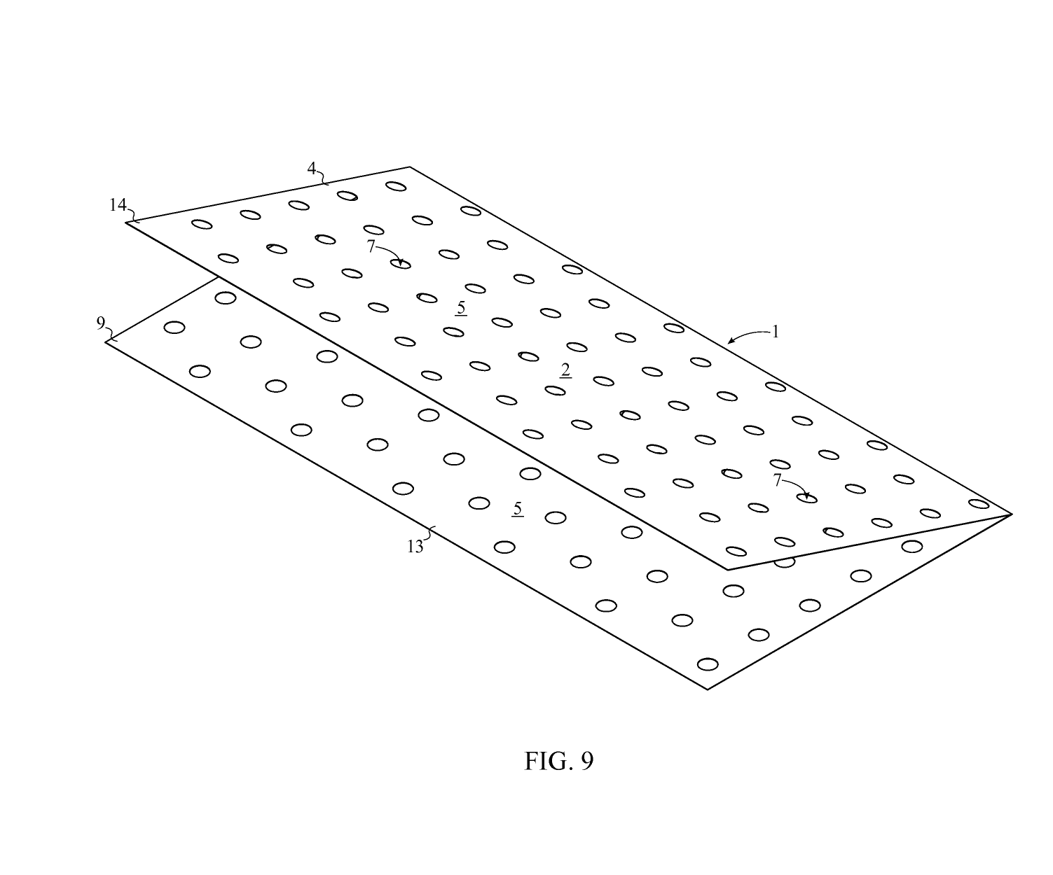

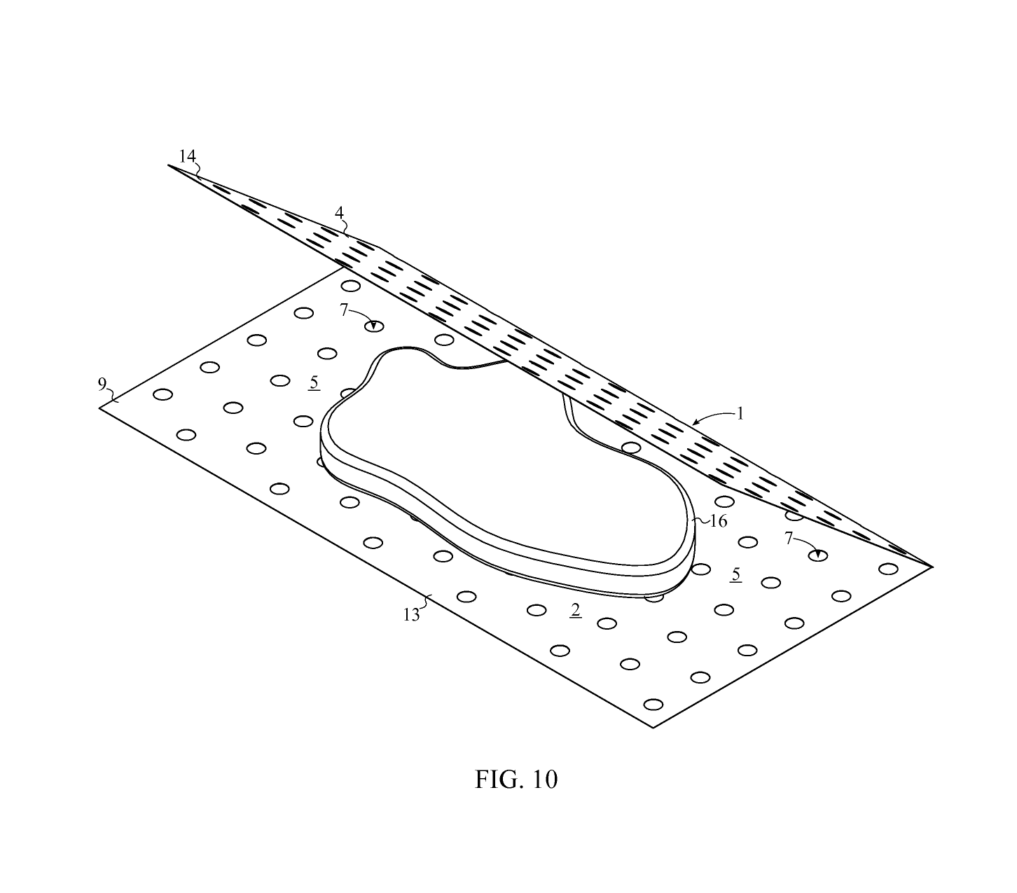

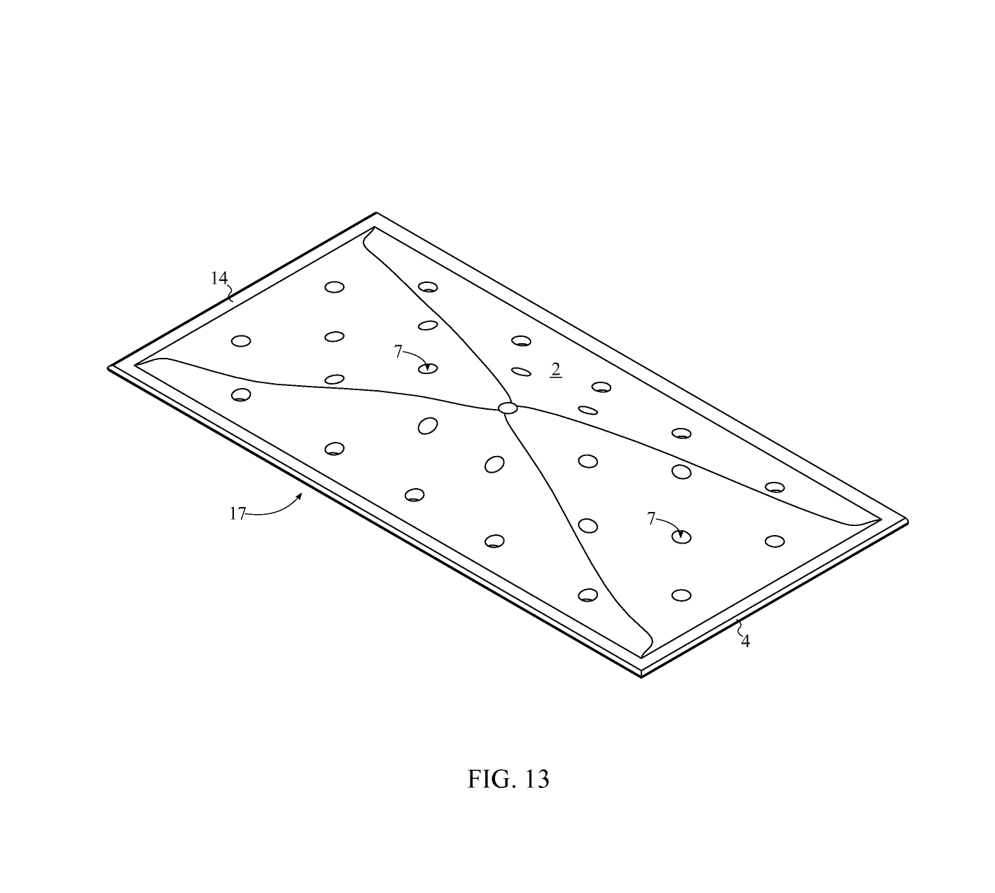

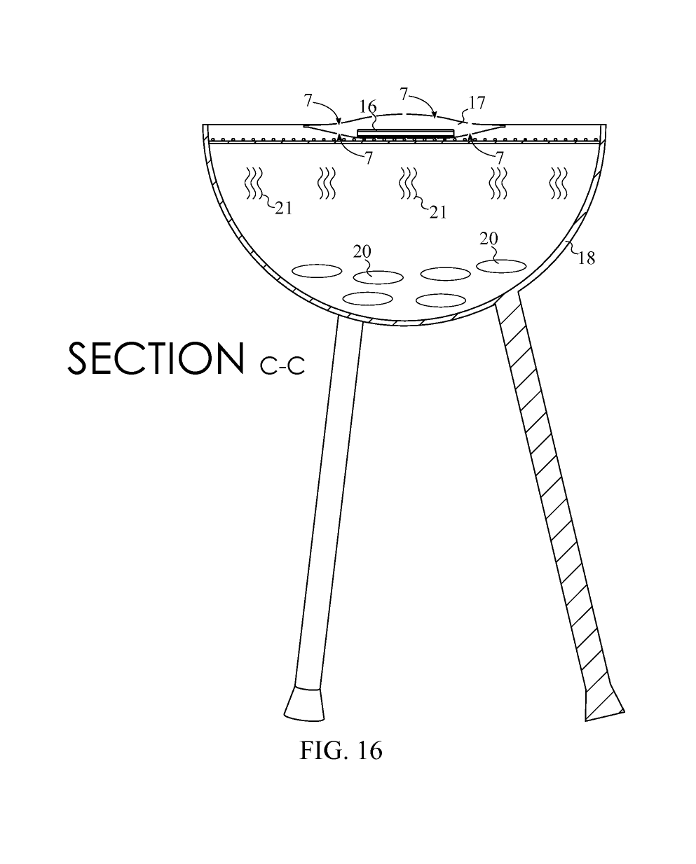

In the preferred embodiment, a sheet of the present invention is rolled onto a kind of spool so that the present invention can be distributed as a rolled product similar to toilet paper, paper towels, or saran wrap. The object of the present invention is to facilitate the cooking of food on a grilling surface 19. The present invention prevents food from coming into contact with the grilling surface 19 while allowing smoke 21 to come into contact with food during the grilling process in order to enhance the flavor of the food. The present invention is utilized to form a pouch 17 to hold food during the grilling process. The malleable metallic sheet 1 is divided into a first fold section 13 and a second fold section 14 as shown in FIG. 9. By dividing the malleable metallic sheet 1 into a first fold section 13 and a second fold section 14, the user is able to form a pouch 17 to hold food during the grilling process. As shown in FIG. 10, uncooked food 16 is positioned onto the first fold section 13, adjacent to the non-stick grip coating 9 in order to prevent the uncooked food 16 from becoming stuck to the malleable metallic sheet 1. The second fold section 14 is then folded over the first fold section 13 and the uncooked food 16 in order to position the uncooked food 16 in between the second fold section 14 and the first fold section 13. As shown in FIG. 13, the user is then able to form a pouch 17 in between the first fold section 13 and the second fold section 14 by crimping together the margin portion 4 of the first fold section 13 and the margin portion 4 of the second fold section 14, wherein the pouch 17 contains the uncooked food 16. The uncooked food 16 is safely contained within the pouch 17 as shown in FIG. 16 as the crimping effectively perimetrically seals the pouch 17.

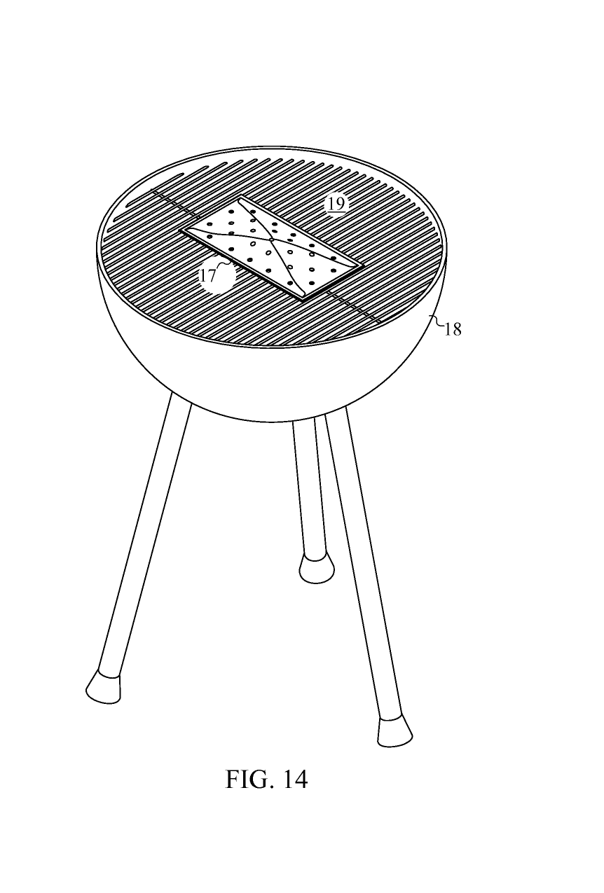

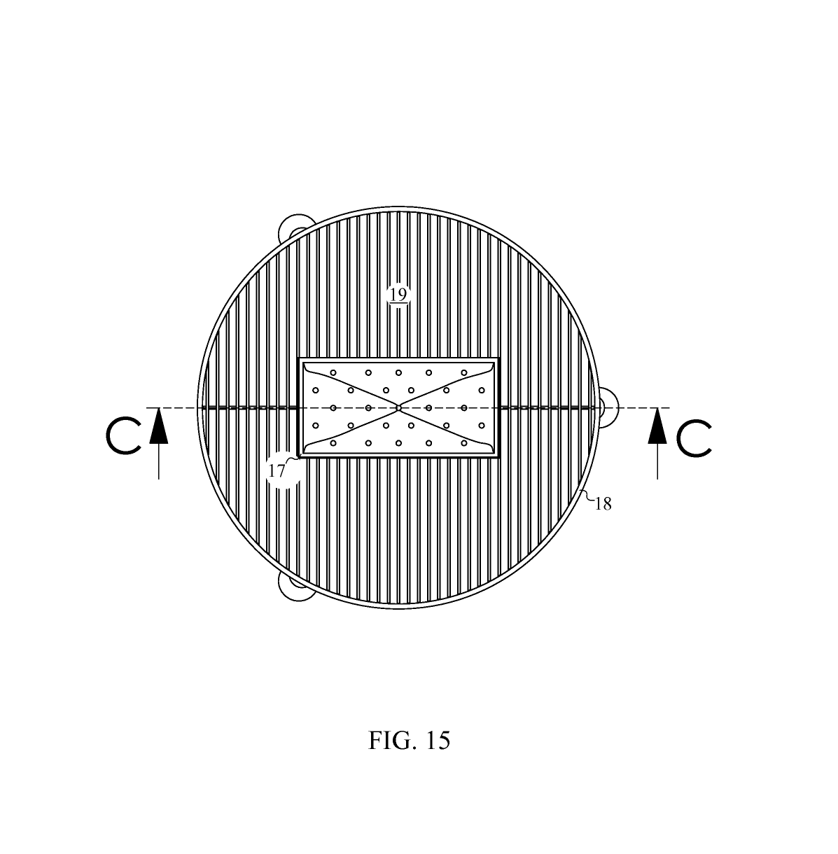

After the pouch 17 is formed, the pouch 17 is placed onto a grilling surface 19 of a charcoal or wood grill 18 as shown in FIGS. 14-15. The pouch 17 is able to hold the uncooked food 16 in place on the grilling surface 19 during the grilling process. The user is then able to ignite a fuel source 20 within the charcoal or wood grill 18 in order to initiate a cooking process for the uncooked food 16. As heat is generated by the combustion of the fuel source 20, the uncooked food 16 within the pouch 17 is slowly cooked. Additionally, smoke 21 seeps from the combusting fuel source 20 through the plurality of ventilation holes 7 into the food during the cooking process as shown in FIG. 16. The smoke 21 entering the interior of the pouch 17 is able to come into contact with the cooking food in order to enhance the flavor of the food with charcoal and wood flavors.

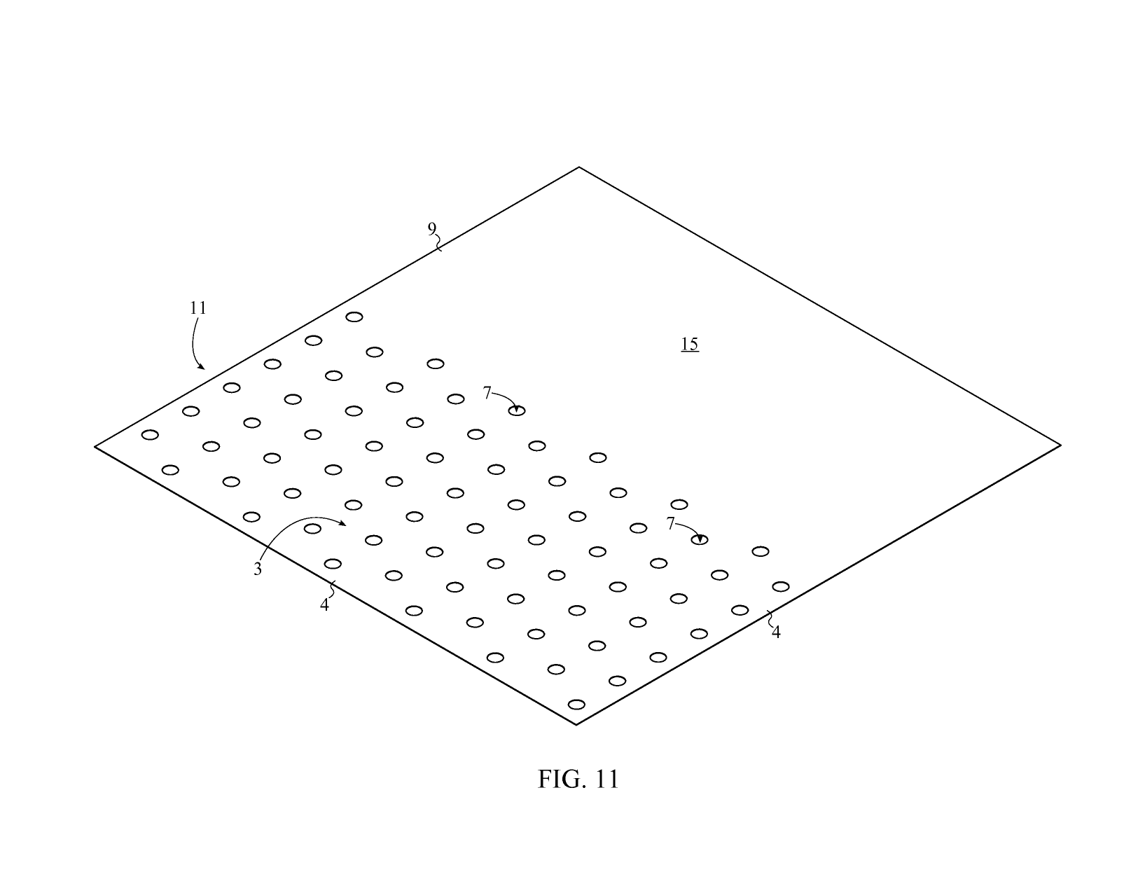

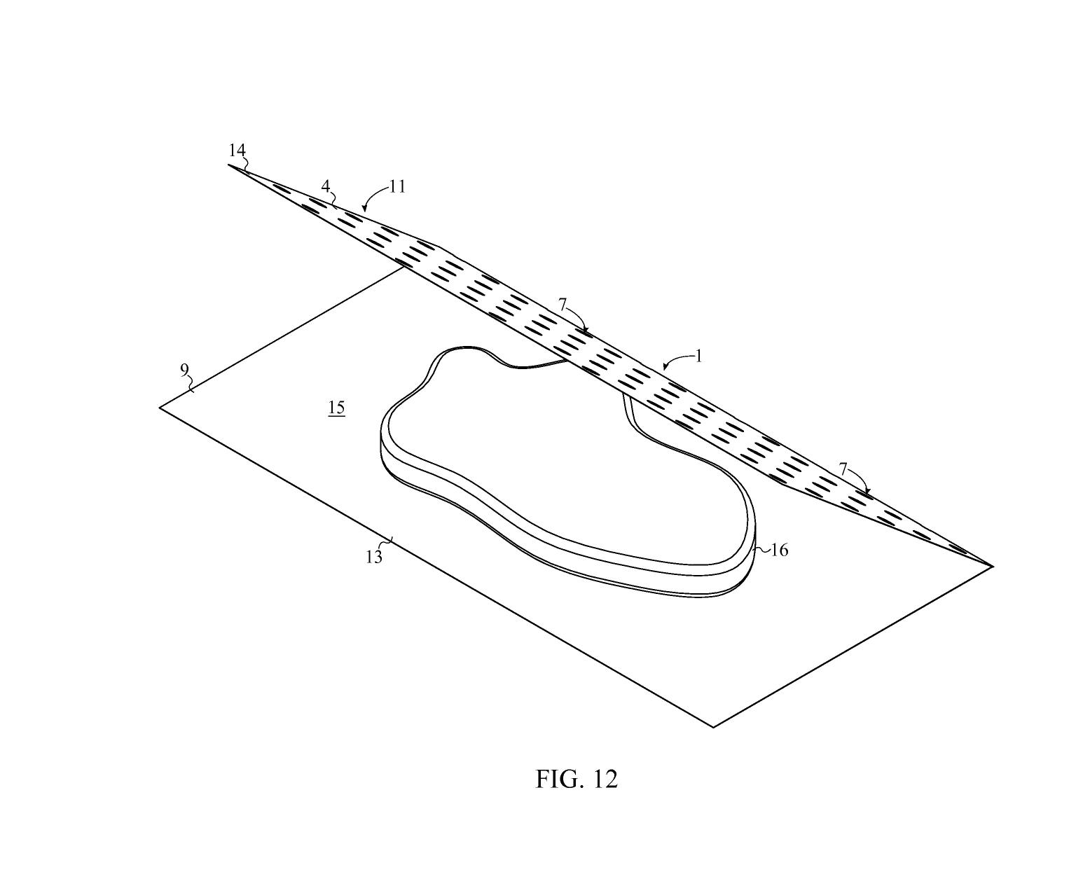

During the grilling process, it is often desirable to prevent sauces as well as flavorful juices from escaping from the interior of the pouch 17. While the plurality of ventilation holes 7 allows smoke 21 to come into contact with cooking food, the plurality of ventilation holes 7 additionally presents an opportunity for the sauces and juices to escape, and, consequently, the first embodiment of the present invention must be used during the cooking process. As such, as shown in FIG. 11, a chosen set of hole sets 11 from the plurality of ventilation hole sets 10 may be designated as a second fold section 14. A solid sheet section 15 may be designated as a first fold section 13. With reference to FIG. 12, the uncooked food 16 is placed onto the solid sheet section 15 in order to prevent sauces and juices from escaping downward and into the grill 18 through the plurality of ventilation holes 7. The chosen set of hole sets 11 is then placed over the uncooked food 16 in order to position the chosen set of hole sets 11 over the uncooked food 16, allowing smoke 21 to enter into the pouch 17 during the cooking process. If the loss of sauces and juices is not a concern, then the second embodiment of the present invention can be used during the cooking process as the plurality of ventilation holes 7 is evenly distributed across the first fold section 13 and the second fold section 14 in the second embodiment of the present invention. the plurality of ventilation holes 7 is evenly distributed across the first fold section 13 and the second fold section 14 as there is no concern over sauces and juices escaping downward into the grill 18.

The present invention may be utilized when grilling various types of foods including meats, fishes, and vegetables. The first embodiment of the present invention in which the plurality of ventilation holes 7 is arranged into a plurality of ventilation hole sets 10 is particularly useful for cooking meats and fishes due to the fact that meats and fishes are often considered more flavorful when the meats and fishes retain their sauces and juices. The solid sheet section 15 prevents the sauces and juices from escaping from within the pouch 17 and becoming lost. The second embodiment of the present invention in which the plurality of ventilation holes 7 is arranged into a uniformly-spaced set of holes features the additional benefit of allowing smoke 21 to enter the pouch 17 from both the top and bottom.

Although the present invention has been explained in relation to its preferred embodiment, it is understood that many other possible modifications and variations can be made without departing from the spirit and scope of the present invention as hereinafter claimed.

What is claimed is:

1. A perforated grilling foil comprises:
a malleable metallic sheet;
a plurality of ventilation holes;
a non-stick grip coating;
the malleable metallic sheet comprises a first surface, a second surface, a margin portion, and a food-contact portion;
the first surface and the second surface being positioned opposite to each other;
the margin portion being peripherally positioned around the food-contact portion;
the plurality of ventilation holes being distributed across the food-contact portion;
the plurality of ventilation holes traversing through the food-contact portion from the first surface to the second surface; and
the non-stick grip coating being superimposed upon the second surface.

2. The perforated grilling foil as claimed in claim 1, wherein the malleable metallic sheet is made of aluminum.

3. The perforated grilling foil as claimed in claim 1, wherein an optimal thickness of the malleable metallic sheet is 0.25 microns.

4. The perforated grilling foil as claimed in claim 1, wherein an optimal diameter of each of the plurality of ventilation holes is 7 millimeters.

5. The perforated grilling foil as claimed in claim 1 further comprises:
the plurality of ventilation holes being arranged into a plurality of ventilation hole sets; and
the plurality of ventilation hole sets being offset from each other across the food-contact portion.

6. The perforated grilling foil as claimed in claim 5 further comprises:
the plurality of ventilation hole sets being offset from each other by a specified distance of 152.4 millimeters.

7. The perforated grilling foil as claimed in claim 1 further comprises:
the plurality of ventilation holes being arranged into a uniformly-spaced set of holes; and
the uniformly-spaced set of holes being positioned across the food-contact portion.

8. A method of utilizing the perforated grilling foil as claimed in claim 1 to cook food, the method comprises the steps of:
dividing the malleable metallic sheet into a first fold section and a second fold section;
positioning uncooked food onto the first fold section, adjacent to the non-stick grip coating;
folding the second fold section over the first fold section and the uncooked food;
forming a pouch in between the first fold section and the second fold section by crimping together the margin portion of the first fold section and the margin portion of the second fold section, wherein in the pouch contains the uncooked food;
placing the pouch onto a grilling surface of a charcoal/wood grill;
igniting a fuel source within the charcoal/wood grill in order to initiate a cooking process for the food; and
seeping smoke from the fuel source through the plurality of ventilation holes into the food during the cooking process.

9. The method of utilizing the perforated grilling foil to cook food as claimed in claim 8, the method comprises the steps of:
providing a chosen set of hole sets from the plurality of ventilation hole sets on the second fold section;
providing a solid sheet section on the first fold section;
placing the uncooked food onto the solid sheet section; and
placing the chosen set of hole sets over the uncooked food.

10. The method of utilizing the perforated grilling foil to cook food as claimed in claim 8, wherein the plurality of ventilation holes is evenly distributed across the first fold section and the second fold section.

11. A perforated grilling foil comprises:
a malleable metallic sheet;
a plurality of ventilation holes;
a non-stick grip coating;
the malleable metallic sheet comprises a first surface, a second surface, a margin portion, and a food-contact portion;
the first surface and the second surface being positioned opposite to each other;
the margin portion being peripherally positioned around the food-contact portion;
the plurality of ventilation holes being distributed across the food-contact portion;
the plurality of ventilation holes traversing through the food-contact portion from the first surface to the second surface;
the non-stick grip coating being superimposed upon the second surface;
the plurality of ventilation holes being arranged into a uniformly-spaced set of holes; and
the uniformly-spaced set of holes being positioned across the food-contact portion.

12. The perforated grilling foil as claimed in claim 11, wherein the malleable metallic sheet is made of aluminum.

13. The perforated grilling foil as claimed in claim 11, wherein an optimal thickness of the malleable metallic sheet is 0.25 microns.

14. The perforated grilling foil as claimed in claim 11, wherein an optimal diameter of each of the plurality of ventilation holes is 7 millimeters.
